(19) United States
(12) Patent Application Publication
(10) Pub. No.: US 2016/0037586 A1
(43) Pub. Date: Feb. 4, 2016

(54) INDUCTION HEATING APPARATUS

(71) Applicant: HEMLOCK SEMICONDUCTOR CORPORATION, Hemlock, MI (US)

(72) Inventors: Timothy Armstrong, Freeland, MI (US); Matthew Deeg, East Lansing, MI (US); Jennifer Larimer, Saginaw, MI (US); William Larson, Midland, MI (US); Keith McCoy, Midland, MI (US); Michael John Molnar, Freeland, MI (US); James A. Schultz, Bay City, MI (US)

(21) Appl. No.: 14/772,301

(22) PCT Filed: Mar. 10, 2014
(86) PCT No.: PCT/US2014/022596

§ 371 Date: Sep. 2, 2015

Related U.S. Application Data
(60) Provisional application No. 61/791,897, filed on Mar. 15, 2013.

(51) Int. Cl. H05B 6/10; H05B 6/36

(52) U.S. Cl. CPC H05B 6/108; H05B 6/365

(57) ABSTRACT

An induction heating apparatus includes a susceptor defining a reaction chamber. A housing is spaced from the susceptor opposite the reaction chamber and defines a port. A void space is defined between the housing and the susceptor. An induction coil extends through the port and is disposed within the void space for conducting an electric current to heat the susceptor to heat the reaction chamber. A flange comprises a metal material and is coupled to the housing at the port for sealing the port with the induction coil extending through the flange. An isolator is disposed between the flange and the housing to prevent the electric current from passing into the housing.

### CROSS-REFERENCE TO RELATED APPLICATIONS

This application claims priority to and all advantages of PCT Application No. PCT/US2014/022596, filed Mar. 10, 2014, which claims priority to U.S. Provisional Patent Application No. 61/791,897, filed on Mar. 15, 2013, the content of each of the above incorporated herein by reference in their entireties.

### TECHNICAL FIELD

Disclosed herein is an induction heating apparatus.

### BACKGROUND

Induction heating apparatuses for heating a vessel are known in the art. There is a desire to use induction heating apparatuses in combination with hydrogenation or silicon-processing reactors. However, there are difficulties in adapting a conventional induction heating apparatus for use with a silicon-processing reactor. For example, conventional induction heating apparatuses have two different pressure regions, which are defined as a reaction chamber and a void space that surrounds the reaction chamber. The reaction chamber receives a process gas and the void space receives a blanket gas, which typically comprises an inert gas, such as argon or nitrogen. Because a pressure in the void space is typically greater than a pressure in the reaction chamber, the blanket gas may migrate from the void space into the reaction chamber. Such a migration of the inert blanket gas, especially in hydrogenation or silicon-processing reactors, is undesirable due to increase complications and costs to subsequently separate the inert blanket gas from the process gas or byproduct thereof. Furthermore, under certain conditions, the inert blanket gas may actual react with the process gas or materials within the reaction chamber to form undesired species. Therefore, there remains a need to provide an improved induction heating apparatus for use with hydrogenation or silicon processing reactors.

### SUMMARY

An induction heating apparatus includes a susceptor defining a reaction chamber. A housing is spaced from the susceptor opposite the reaction chamber. The housing defines a port. A void space is defined between the housing and the susceptor. An induction coil extends through the port and is disposed within the void space for conducting an electric current to generate a magnetic field that inductively heats the susceptor. Heating the susceptor heats the reaction chamber to a desired temperature. A flange comprises a metal material and is coupled to the housing at the port for sealing the port with the induction coil extending through the flange. An isolator is disposed between the flange and the housing to prevent the electric current from passing into the housing. Providing the flange made from the metal material allows the flange to seal the port while being exposed to the desired temperature and pressure of the induction heating apparatus.

A method of heating the reaction chamber using the induction heating apparatus is also described.

### BRIEF DESCRIPTION OF THE DRAWINGS

The following is a brief description of the drawings wherein like elements are numbered alike and which are exemplary of the various embodiments described herein.

FIG. 1 is a cross-sectional view of a portion of an induction heating apparatus having a susceptor defining a reaction chamber and an induction coil;

FIG. 2 is a cross-sectional view of a portion of the induction heating apparatus with an interior wall defining the reaction chamber;

FIG. 3 is a cross-sectional view of a portion of the induction heating apparatus showing a gas distributor at one end of the susceptor;

FIG. 4 is a cross-sectional view of a portion of the induction heating apparatus showing a flange sealing a port of the induction heating apparatus;

FIG. 5 is a cross-sectional view of a portion of the induction heating apparatus having a barrier wall separating the susceptor and the induction coil; and

FIG. 6 is a cross-sectional view of a portion of the induction heating apparatus showing a first flange and a second flange spaced from the first flange.

### DETAILED DESCRIPTION

Referring to the Figures, wherein like numerals indicate like or corresponding parts throughout the several views, an induction heating apparatus is generally shown at 10. Generally, the induction heating apparatus 10 is used to heat a reaction chamber 12 to a desired temperature. The heating of the reaction chamber 12 by the induction heating apparatus 10 can be used in a variety of applications. For example, the induction heat apparatus can be used as a fluidized bed reactor, a hydrogenation reactor, a fixed bed reactor, a moving bed reactor, a physical vapor transport reactor, a freespace reactor, a CVD reactor, a melting reactor, a crystal growth reactor, and an epitaxial reactor.

In one embodiment, the induction heating apparatus 10 is used as a silicon-processing reactor. For example, the induction heating apparatus 10 can be used as a fluidized bed reactor for thermally decomposing a silicon containing gas to deposit a material on a seed element, such as thermal decomposing trichlorosilane to deposit silicon on the seed element. Additionally, the induction heating apparatus 10 can be used as a hydrogenation reactor. For example, the induction heating apparatus 10 can be used for the hydrogenation of silicon tetrachloride to produce trichlorosilane.

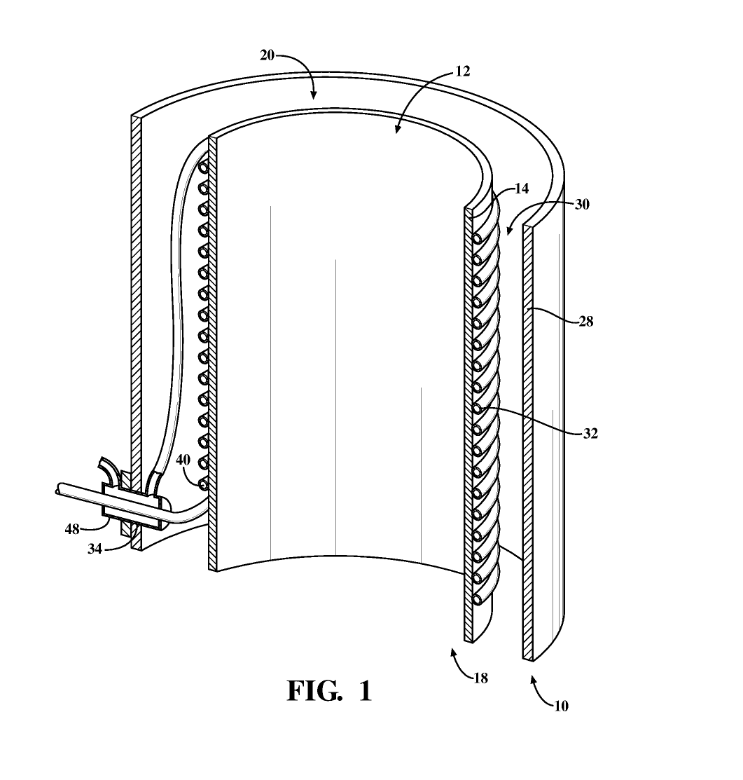

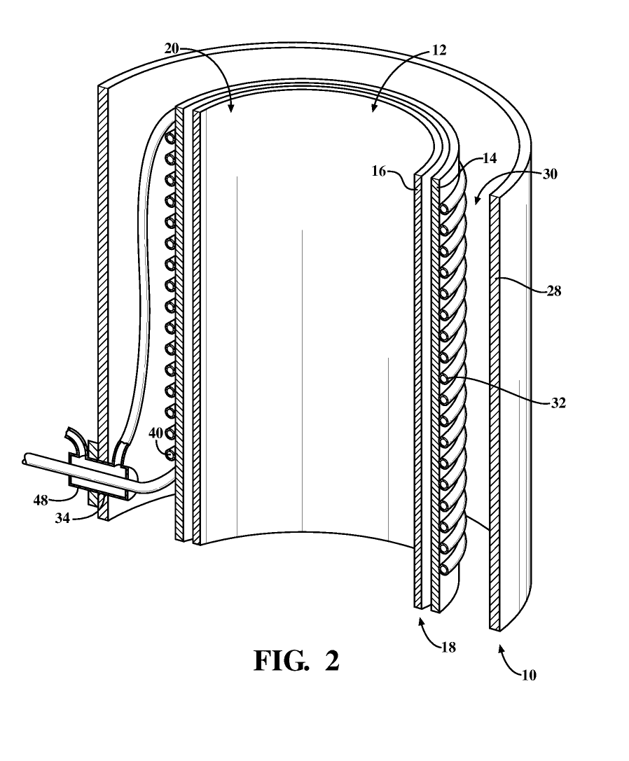

With reference to FIG. 1, the induction heating apparatus 10 includes a susceptor 14. Generally, the susceptor 14 defines the reaction chamber 12. More specifically, the susceptor 14 is a reactor wall, which defines the reaction chamber 12. However, as shown in FIG. 2, it is to be appreciated that the induction heating apparatus 10 may include an internal wall 16 adjacent the susceptor 14 with the internal wall 16 defining the reaction chamber 12. Said differently, when the internal wall 16 is present, the susceptor 14 surrounds the internal wall 16 outside the reaction chamber 12. It is to be appreciated that the susceptor 14 may not completely surround the internal wall 16. For example, only a portion of the internal wall 16 may be surrounded by the susceptor 14.

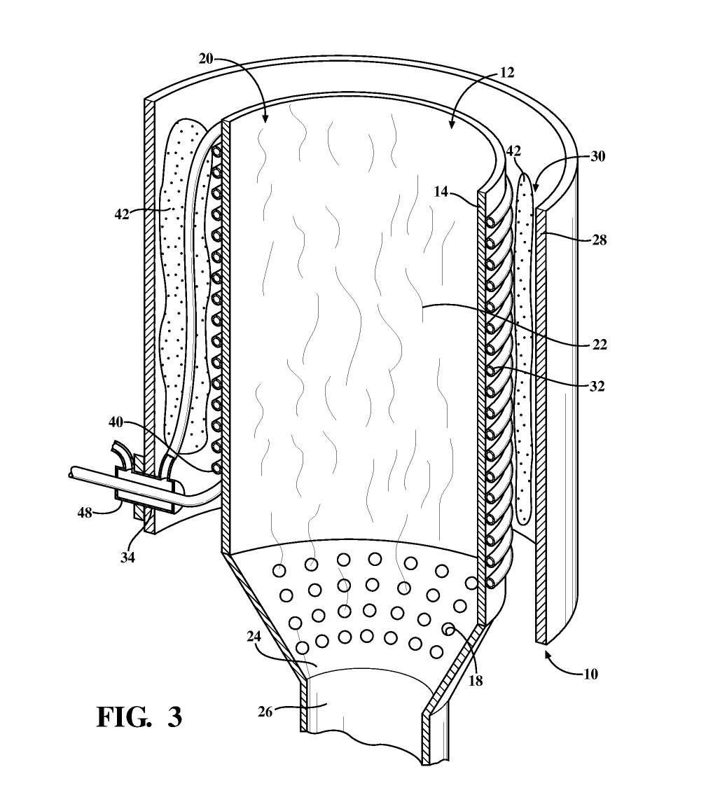

It is to be appreciated that the susceptor 14 and, if present, the internal wall 16, may define at least one inlet 18 and at least one outlet 20. The inlet 18 is used to introduce a process gas 22 (shown in FIG. 3), which may be the silicon containing gas, into the reaction chamber 12. The outlet 20 is used to exhaust the process gas 22, or a byproduct thereof, from the reaction chamber 12. The process gas 22 is typically disposed in the reaction chamber 12 during operation of the induction heating apparatus 10. As shown in FIG. 3, when the induction heating apparatus 10 is used as the fluidized bed reactor, the process gas 22 comprises the material to be deposited on the seed elements, or a precursor thereof. When the induction heating apparatus 10 is used for hydrogenation, the process gas 22 comprises a halogen containing silicon species and the byproduct comprises hydrogenated halogen containing silicon species. This could, for example be used to hydrogenate silicon tetrachloride to trichlorosilane.

With reference to FIG. 3, the susceptor 14 may include a gas distributor 24 for introducing the process gas 22 into the reaction chamber 12. When present, the gas distributor 24 defines the inlet 18. Additionally, the induction heating apparatus 10 may include a product collection opening 26. When present, the product collection opening 26 may be defined by the susceptor 14, the internal wall 16, and/or the gas distributor 24 for allowing the seed elements with the material deposited on thereon to exit the reaction chamber 12. Furthermore, the internal wall 16 may define openings for introducing particles or gasses into the reaction chamber 12.

With reference to FIG. 1, the induction heating apparatus 10 also includes a housing 28 spaced from the susceptor 14 opposite the reaction chamber 12. Said differently, the housing 28 surrounds the susceptor 14 and the reaction chamber 12. Generally, the housing 28 is the outer shell of the induction heating apparatus 10. Because the housing 28 is spaced from the susceptor 14, a void space 30 is defined between the housing 28 and the susceptor 14.

An induction coil 32 is disposed within the void space 30. Generally, the induction coil 32 is wound about the susceptor 14 within the void space 30. Typically, the induction coil 32 is spaced from the susceptor 14. The induction coil 32 comprises a highly electrically conductive material, such as copper, oxygen free copper, silver, nickel, Inconel®, gold, and combinations thereof. However, it is to be appreciated that the induction coil 32 may comprise any suitable material. The induction coil 32 conducts an electric current for generating a magnetic field that inductively heats the susceptor 14. Typically, the susceptor 14 comprises graphite for receiving the magnetic field. However, it is to be appreciated that the susceptor 14 may comprise any suitable material. It is also to be appreciated that multiple coils could be used to heat different zones of the reaction chamber 12.

Heating the susceptor 14 results in a heating of the reaction chamber 12 to the desired temperature. The desired temperature will vary depending on the type of process to be completed in the reaction chamber 12. For example, the reaction chamber 12 is typically heated from about 25 to about 1350 degrees Celsius.

The housing 28 defines a port 34 for allowing access to the void space 30 from an exterior of the housing 28. The induction coil 32 extends through the port 34 such that the induction coil 32 can be disposed within the void space 30. The induction coil 32 includes a supply stem 36 at one end of the induction coil 32 and a return stem 38 at another end of the induction coil 32. At least one of the supply stem 36 and the return stem 38 extend through the port 34 of the housing 28.

The resistance of the induction coil 32 to conduct the electric current results in a heating of the induction coil 32. As such, the induction coil 32 may define an internal passage 40 for circulating a cooling medium to reduce a temperature of the induction coil 32. More specifically, the internal passage 40 of the induction coil 32 is defined by a hollow interior of the induction coil 32, such that the induction coil 32 is tubular. As the cooling medium is circulated through the induction coil 32, heat is transferred from the induction coil 32 to the cooling medium thereby reducing the temperature of the induction coil 32. As such, the cooling medium prevents the excessive heating of the induction coil 32, which can result in a failure of the induction coil 32.

With reference to FIG. 3, the induction heating apparatus 10 may include a blanket gas 42 disposed within the void space 30. Generally, the blanket gas 42 prevents the process gas 22 within the reaction chamber 12 from leaking into the void space 30. For example, the operating pressure of the blanket gas 42 may be greater than the pressure within the reaction chamber 12 such that the blanket gas 42 may enter the reaction chamber 12. Therefore, the blanket gas 42 is selected to minimize the impact the blanket gas 42 may have on the reaction within the reaction chamber 12 or with downstream processes, such as gas recovery or gas recycling.

The blanket gas 42 is typically a halo-hydrogen, halo-silicon, or halo-hydrogen-silicon species. More specifically, the blanket gas 42 may be selected from the group of silicon tetrachloride, hydrogen chloride, bromosilane, silicon tetrafluoride, and combinations thereof. Provided the blanket gas 42 comprises a gas from the aforementioned list, the blanket gas 42 will prevent deposition of materials comprising the process gas 22 onto components within the void space 30 or housing 28. The blanket gas 42 may also comprise gasses compatible with the process gas 22 or resulting products for ease of separation and post processing downstream of the reaction chamber 12. It is to be appreciated that the operating pressure of the blanket gas 42 may be less than the pressure within the reaction chamber 12 such that the process gas 22 may enter the void space 30.

The selection of the cooling medium is targeted to be chemically compatible with the blanket gas 42 to avoid adverse reactions, resulting in process upsets or releases. For example, because the induction coil 32 is within the void space 30, which comprises the blanket gas 42, there is a reasonable chance the cooling medium may come in contact with the blanket gas 42 within the void space 30. This may occur, for example, due to installation of components, mechanical failure of parts or leaking connections within the system. Introduction of the cooling medium into the void space 30 may result in an undesired reaction between the cooling medium and the blanket gas 42. For example, if the blanket gas 42 comprised hydrogen chloride or silicon tetrachloride, the reaction between de-ionized water and the blanket gas 42 would produce hydrochloric acid, hydrogen chloride, and significant heat, which could significantly increase the system pressure, potentially upsetting the processes, or resulting in an undesired chemical release. Therefore, the cooling medium typically comprises an organic heat transfer fluid and/or a silicone based heat transfer fluid. More specifically, the cooling medium may be selected from the group of alkyl, phenyl, and silicone based fluids, and combinations thereof. It is to be appreciated that de-ionized water could also be used, or mixtures of glycol and de-ionized water. It is also to be appreciated that the cooling medium can be any acceptable heat transfer medium that is not electrically conductive.

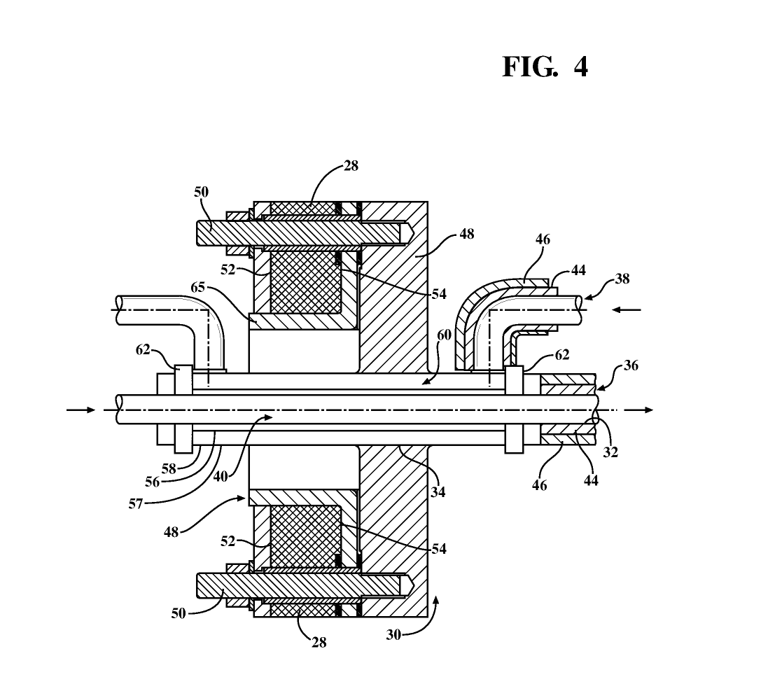

With reference to FIG. 4, the induction coil 32 may include a coating to protect the induction coil 32 from the blanket gas 42 within the void space 30. For example, a first material 44 may be disposed on the induction coil 32 for separating the induction coil 32 from the blanket gas 42. Additionally, a second material 46 may be disposed on the first material 44 for further protecting the induction coil 32. Typically, the first material 44 provides corrosion and scratch resistance to the induction coil 32. The second material 46 typically provides chemical resistance to the induction coil 32 from exposure to elements within the void space 30. The second material 46 also provides electrical isolation between turns of the induction coil 32.

Typically, the first material 44 is selected from the group of nickel, platinum, rhodium, ruthenium, silver, and combinations thereof. Additionally, the second material 46 typically comprises a fluorine-containing polymer. For example, the fluorine-containing polymer may be selected from the group of PTFE, ETFE, chloro-fluorpolymers, and combinations thereof. In one embodiment, the induction coil 32 is coated with the first material 44, which is nickel and the first material 44 is coated with the second material 46, which is a fluorine-containing polymer. It is to be appreciated that the first and second material 46 can be disposed on the induction coil 32 by any suitable method. For example, the first material 44 may be disposed on the induction coil 32 by electroplating and the second material 46 can be disposed on the first material 44 by power coating, CVD, PVD, and/or thermal spray.

The induction heating apparatus 10 also includes a flange 48 coupled to the housing 28 at the port 34 for sealing the port 34. The flange 48 may be coupled to the housing 28 by any suitable means. For example, the flange 48 may be coupled to the housing 28 by bolts 50. The flange 48 seals the port 34 in the housing 28 such that the void space 30 can maintain the operating pressure that may be at or different from the atmospheric pressure outside the housing 28. Typically, the operational pressure within the void space 30 is of from about −15 to 500, more typically of from about −15 to 300, and even more typically of from about 25 to 250 PSIG. A gasket may be disposed between the flange 48 and the housing 28 for enhancing the seal of the flange 48 to maintain the operational pressure within the void space 30.

It is to be appreciated that the flange 48 can be internal or external relative to the housing 28. Said differently, the flange 48 may be coupled to an exterior surface 52 of the housing 28 such that the flange 48 is external to the induction heating apparatus 10. Alternatively, the flange 48 may be coupled to an interior surface 54 of the housing 28, as shown in FIG. 4. When the flange 48 is coupled to the housing 28, the blanket gas 42 surrounds the flange 48 for preventing deposition of materials comprising the process gas 22 onto the flange 48.

The induction coil 32 extends through the flange 48 such that the induction coil 32 passes through the port 34 for entering the void space 30 between the housing 28 and the susceptor 14. Typically, the portion of the induction coil 32 that extends through the flange is referred to as a first sleeve 56. More specifically, the supply stem 36 that extends through the port 34 may be further defined as the first sleeve 56. It is to be appreciated that the first sleeve 56 may be a separate component from the induction coil 32 with the induction coil 32 coupled to the first sleeve 56 within the void space 30. Additionally, when the first sleeve 56 is a separate component, the induction coil 32 may be disposed within the first sleeve 56 to enter the void space 30, such that the supply stem 36 extends through the first sleeve. Additionally, the first sleeve 56 may include an insulating layer 57 disposed on an exterior of the first sleeve 56. It is to be appreciated that the flange 48 may contact any one of the first sleeve 56, the insulating layer 57, or the second sleeve for securing the induction coil 32 within the port 34.

The flange 48 may include a second sleeve 58 disposed about the first sleeve 56. If the second sleeve 58 present, the second sleeve 58 is spaced from the first sleeve 56 thereby defining a return path 60 between the first and second sleeves 56, 58. Typically, the supply stem 36 is the first sleeve 56 and the return stem 38 is coupled to the second sleeve 58. Alternatively, when the supply stem 36 is a separate component from the first sleeve 56, the supply stem 36 may extend through the first sleeve 56 and the return stem 38 may be coupled to the second sleeve 58. Generally, the cooling medium passes through the first sleeve 56 and continues through the induction coil 32 within the void space 30 and then returns to the flange 48 to exit the induction heating apparatus 10 through the return path 60 between the first and second sleeves 56, 58.

It is to be appreciated that the first and/or second sleeves 56, 58 may be integral with the induction coil 32. Said differently, the induction coil 32 may not be capable of being separated from the first and/or second sleeves 56, 58 without permanently damaging the induction coil 32, the first sleeve 56, and/or the second sleeve 58.

The flange 48 may further include a plurality of sealing collars 62 for sealing the second sleeve 58 and further defining the return path 60. Generally, when the first and second sleeves 56, 58 are present, the sealing collars 62 coupled the first and second sleeves 56, 58 together in a concentric manner such that the first sleeve 56 is within the second sleeve 58. The sealing collars 62 allow the induction coil 32 to pass through the flange 48 while sealing the return path 60. The sealing collars 62 can be electrical insulators to prevent short-circuiting between the supply and return stems 36, 38 or between the first and second sleeves 56, 58.

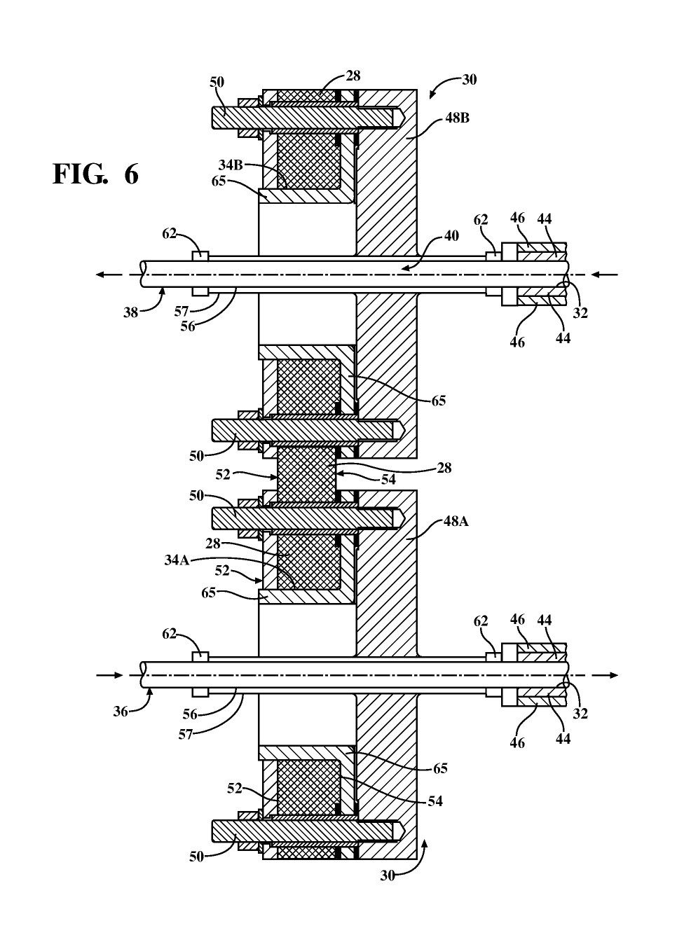

With reference to FIG. 6, the induction heating apparatus 10 may include multiple flanges. For example, the flange 48 described above may be further defined as a first flange 48A and a second flange 48B with the second flange 48B spaced from the first flange 48A. In such an embodiment, each of the first and second flanges 48A, 48B would include the first sleeve 56 and the insulating layer 57 disposed on the first sleeve 56. Additionally, in such an embodiment, the first flange 48A supports the supply stem 36 and the second flange 48B supports a return stem 38 defining the return path 60. Furthermore, in such an embodiment, the housing 28 defines a first port 34A sealed by the first flange 48A and the housing 28 defines a second port 34B sealed by the second flange 48B. Although not shown, it is to be appreciated that the supply stem 36 and the return stem 38 may extend through the same port 34 without contacting each other. Said differently, both the supply stem 36 and the return stem 38 may extend through the port 34 in a spaced apart relationship relative to each other, rather than having the housing 28 define the first and second ports 34A, 34B.

A temperature of the blanket gas 42 heats the flange 48 to an operating temperature. More specifically, because the blanket gas 42 is in direct contact with the flange 48, the operating temperature of the flange 48 is at least, if not greater than the temperature of the blanket gas 42. Therefore, a design temperature for selecting a material of the flange 48 is desired to be above that of the temperature of the blanket gas 42. For example, if silicon tetrachloride is used as the blanket gas 42 at an operational pressure of 250 psi, the temperature of the blanket gas 42 would be above 183 degrees Celsius to ensure a vapor is present in the void space 30. Therefore the design temperature for selecting the material of the flange is at least 183 degrees Celsius which is beyond the Section 10 ASME Code limit for commonly used materials for prior art flanges, such as engineered plastics and fiberglass.

Typically, the operating temperature of the flange 48 is of from about 0 to about 500, more typically of from about 20 to about 300, and even more typically of from about 125 to about 250 degrees Celsius. Therefore, the flange 48 comprises a metal material for providing heat resistance when the flange 48 is subjected to the operating temperature. Using the metal material for the flange 48 allows the flange 48 to meet a target strength and resist deformation or failure when exposed to the operating temperature so that the flange 48 can seal the port 34, even when the flange 48 is exposed to the operating temperature. Examples of suitable metal materials for the flange include, Nickel Alloys, such as Inconel®, Incoloy®, carbon steel, stainless steel, copper, duplex stainless steel, and combinations thereof.

Because the flange 48 comprises the metal material, an isolator 65 may be disposed between the flange 48 and the housing 28 to prevent the electric current traveling through the induction coil 32 from passing into the housing 28. Additionally, the isolator 65 may line the housing 28 within the port 34. In contrast to the flange 48, the isolator 65 is not considered a code part under the ASME Pressure Vessel code and therefore the isolator 65 not subject to the thermal limitation for operation as described in Section 10. The driving consideration for the selection of the isolator material is chemical compatibility with the target environment, in this case the blanket gas 42. Examples of suitable material types for the isolator 65 include ceramics such as silicon nitride, zirconia, or alumina, or engineered plastics such as PEEK or NEMA Grade G-9 or NEMA Grade G-11.

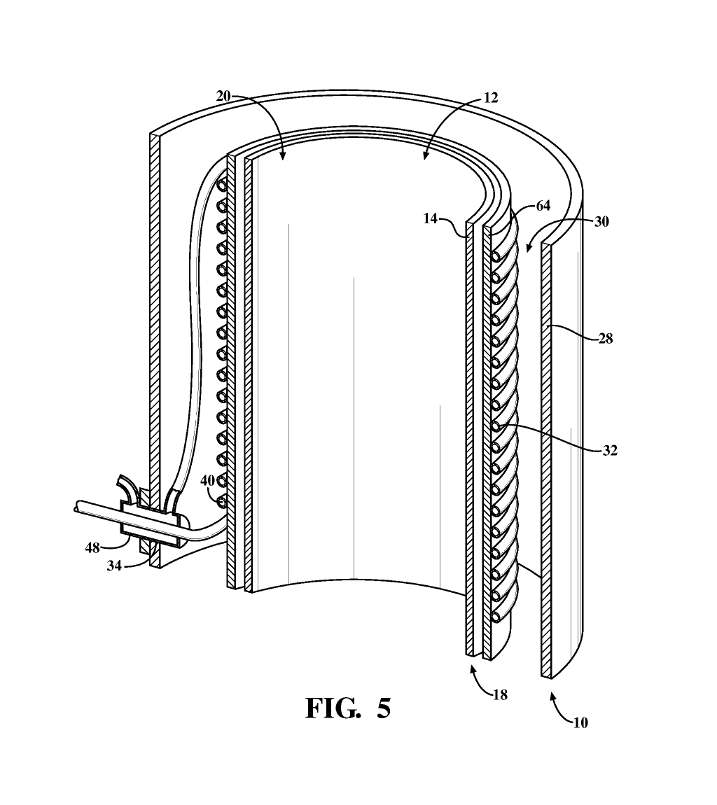

With reference to FIG. 5, the induction heating apparatus 10 may include a barrier wall 64 separating the susceptor 14 and the induction coil 32. As such, the void space 30 is defined between the barrier wall 64 and the housing 28. The barrier wall 64 provides additional separation between the blanket gas 42 and the processing gas 22. The barrier wall 64 also prevents the process gas 22 from contacting the induction coil 32.

The induction heating apparatus 10 may include an insulting barrier surrounding the susceptor 14 opposite the reaction chamber 12. When the insulating barrier is present, the housing 28 surrounds the insulating layer opposite the susceptor 14 with the void space 30 defined between the housing 28 and the insulting layer. The induction heating apparatus 10 may include a first heat shield disposed between the susceptor 14 and the insulating layer. Additionally, the induction heating apparatus 10 may include a second heat shield disposed between the insulating layer and the inductive coils. It is to be appreciated that the insulating barrier and/or the heat shields may be used as the barrier wall 64. The insulating barrier and the heat shields assist with maintaining the desired temperature within the reaction chamber 12. Typically, the barrier wall 64 comprises a material selected from the group of graphite, silicon carbide, metal silicides, ceramics, carbon fiber, carbon composite, flexible graphite, metal foils, quartz, and combinations thereof. Additionally, the heat shield may be used to create a secondary containment between the induction coil 32 and the susceptor 14 to separate the induction coil 32 from the susceptor 14. Separation between the induction coil 32 and the susceptor 14 prevents the blanket gas from contacting the susceptor 14 while still surrounding the induction coil 32.

A method of heating the reaction chamber 12 using the induction heating apparatus 10 is described below. The method includes the step of introducing the process gas 22 within the reaction chamber 12. The induction coil 32 is energized with the electric current to generate the magnetic field thereby inductively heating the susceptor 14 with the magnetic field. The reaction chamber 12 is heated to the desired temperature with radiant heat from the heated susceptor 14 thereby heating the process gas 22. The blanket gas 42 is introduced within the void space 30 for preventing the process gas 22 within the reaction chamber 12 from leaking into the void space 30.

It is to be appreciated that when the susceptor 14 is further defined as the reactor for hydrogenation, the method may further comprise the step of recovering a component from the process gas 22 within the reaction chamber 12. In the case of chlorine-hydrogenating silicon reactors, the component would be trichlorosilane. Additionally, when the susceptor 14 is further defined as the housing 28 of a fluidized bed reactor, the method may further comprise the step of fluidizing seed elements within the reaction chamber 12 to grow a material on the seed elements. As described above, the method may include the step of coating the induction coil 32 with the first material 44 and/or the second material 46. Additionally, the method may include the step of passing the cooling medium through the induction coil 32 for cooling the induction coil 32.

### EXAMPLES

Chemically compatibility testing was completed to screen which engineered plastics/re-enforced fiberglass materials would be acceptable to use in hydrogenation or silicon processing reactors. This testing was completed by obtaining samples of potential material options and soaking them in the target chemical (the chemical the isolator will be in contact with) for a total period of 28 days. The pre-exposure weight along with the soaked weight of the sample was taken at 7, 14, 21 and 28 days. Table 1 contains data of the percent Swell observed of for the tested materials at each of the data points. The percent Swell was calculated by subtracting the starting weight from the measured weight of the sample at the given time interval then dividing by the sample starting weight and multiplying by 100.

TABLE 1
Material Compatibility Testing: Percent Swell

| Material | 7 Days | 14 Days | 21 Days | 28 Days |
|---|---|---|---|---|
| PEEK | 1.1% | 1.1% | 1.1% | 1.6% |
| PTFE | 0.1% | 0.1% | 0.1% | 0.3% |
| NEMA Grade | 15.1% | 18.8% | 21.4% | 22.4% |
| G-7 | | | | |
| NEMA Grade | 0.6% | 0.6% | 0.6% | 0.6% |
| G-9 | | | | |
| NEMA Grade | 10.8% | 8.1% | 7.0% | 6.5% |
| G-10 | | | | |
| NEMA Grade | 0.5% | 0.5% | 0.5% | 0.5% |
| G-11 | | | | |

From the table, the materials having acceptable percentages of Swell were determined to include PEEK, PTFE, NEMA Grade G-9, and NEMA Grade G-11.

Obviously, many modifications and variations of the present invention are possible in light of the above teachings. The foregoing invention has been described in accordance with the relevant legal standards; thus, the description is exemplary rather than limiting in nature. Variations and modifications to the disclosed embodiment may become apparent to those skilled in the art and do come within the scope of the invention. Accordingly, the scope of legal protection afforded this invention may only be determined by studying the following claims.

The singular forms “a,” “an,” and “the” include plural referents unless the context clearly dictates otherwise. “Or” means “and/or.” The modifier “about” used in connection with a quantity is inclusive of the stated value and has the meaning dictated by the context (e.g., includes the degree of error associated with measurement of the particular quantity). The notation “±10%” means that the indicated measurement can be from an amount that is minus 10% to an amount that is plus 10% of the stated value. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group.

The suffix “(s)” is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs. A “combination” is inclusive of blends, mixtures, alloys, reaction products, and the like.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1-39. (canceled)

40. An induction heating apparatus comprising:
a susceptor defining a reaction chamber;
a housing spaced from said susceptor opposite said reaction chamber with a void space defined between said housing and said susceptor and said housing defining a port;
an induction coil extending through said port and disposed within said void space for conducting an electric current to generate a magnetic field that inductively heats said susceptor thereby heating said reaction chamber to a desired temperature;
a flange comprising a metal material and coupled to said housing at said port for sealing said port with said induction coil extending through said flange; and
an isolator disposed between said flange and said housing to prevent the electric current from passing into said housing.

41. An induction heating apparatus as set forth in claim 40, further comprising a blanket gas disposed within said void space for preventing a process gas within said reaction chamber from leaking into said void space.

42. An induction heating apparatus as set forth in claim 41, further comprising a barrier wall separating said susceptor and said induction coil for separating said blanket gas from the processing gas and to prevent the process gas from contacting said induction coils.

43. An induction heating apparatus as set forth in claim 42, wherein said barrier wall comprises a material selected from the group of graphite, silicon carbide, metal silicides, ceramics, carbon fiber, carbon composite, flexible graphite, metal foils, quartz, and combinations thereof.

44. An induction heating apparatus as set forth in claim 41, wherein the said blanket gas is a halo-hydrogen, halo-silicon, or halo-hydrogen-silicon material.

45. An induction heating apparatus as set forth in claim 40, wherein said flange seals said port in said housing such that said reaction chamber and said void space have an operating pressure at or different than an atmospheric pressure outside said housing.

46. An induction heating apparatus as set forth in claim 40, wherein said induction coil defines an internal passage for circulating a cooling medium for cooling said induction coil.

47. An induction heating apparatus as set forth in claim 40, wherein a portion of said induction coil extending though said port is further defined as a first sleeve and said flange includes a second sleeve disposed about said first sleeve such that a return path is defined between said first and second sleeves.

48. An induction heating apparatus as set forth in claim 47, wherein said induction coil is coupled to said first sleeve and said second sleeve such that said cooling medium flows though said first sleeve, through said induction coil, and through said return path to exit said induction heating apparatus.

49. An induction heating apparatus as set forth in claim 47, wherein said flange further includes a plurality of sealing collars for sealing said first and second sleeves and further defining said return path thought said second sleeve.

50. An induction heating apparatus as set forth in claim 47, wherein said first and second sleeves are integral with said induction coil.

51. An induction heating apparatus as set forth in claim 40, wherein a first material is disposed on said induction coil and a second material is disposed on said first material for protecting said induction coil wherein said first material is selected from the group of nickel, platinum, rhodium, ruthenium, silver, and combinations thereof, wherein said second material comprises a fluorine containing polymer selected from the group of PTFE, ETFE, chloro-fluorpolymers, and combinations thereof.

52. An induction heating apparatus as set forth in claim 40, wherein said flange is coupled to an exterior surface of said housing.

53. An induction heating apparatus as set forth in claim 40, wherein said flange is coupled to an interior surface of said housing.

54. An induction heating apparatus as set forth in claim 40, wherein said isolator comprises a material selected from the group of silicon nitride, alumina, zirconia, PEEK, NEMA Grade G-9, or NEMA Grade G-11, and combinations thereof.

55. A method of heating a reaction chamber using an induction heating apparatus wherein the induction heating apparatus includes a susceptor defining the reaction chamber, a housing spaced from the susceptor opposite the reaction chamber with a void space defined between the housing and the susceptor and the housing defines a port, an induction coil extending through the port and disposed within the void space, a flange comprising a metal material and coupled to the housing at the port for sealing the port, and a isolator disposed between the flange and the housing to prevent the electric current from passing into the housing, said method comprising the steps of:
introducing a process gas within the reaction chamber;
energizing the induction coil with an electric current to generate a magnetic field thereby inductively heating the susceptor with the magnetic field;
heating the reaction chamber to a desired temperature with radiant heat from the heated susceptor to heat the process gas; and
introducing a blanket gas within the void space for preventing the process gas within the reaction chamber from leaking into the void space.

56. A method as set forth in claim 55, further comprising coupling the flange to an interior surface of the housing.

57. A method as set forth in claim 55, further comprising coupling the flange to an exterior surface of the housing such that the flange is external to the induction heating apparatus.

58. A method as set forth in claim 55, further comprising coating the induction coil with a first material selected from the group of nickel, platinum, rhodium, ruthenium, silver, and combinations thereof.

59. A method as set forth in claim 58, further comprising coating the first material with a second material comprises a fluorine containing polymer selected from the group of PTFE, ETFE, chloro-fluorpolymers, and combinations thereof.
